(19) United States
(12) Patent Application Publication
(10) Pub. No.: US 2020/0168007 A1
(43) Pub. Date: May 28, 2020

(54) INFORMATION PROCESSING APPARATUS, METHOD FOR CONTROLLING INFORMATION PROCESSING APPARATUS, COMMUNICATION APPARATUS, METHOD FOR CONTROLLING COMMUNICATION APPARATUS AND STORAGE MEDIUM FOR PRIORITY PASSAGE IN ACCOMPANIMENT OF FEE

(71) Applicant: HONDA MOTOR CO., LTD., Tokyo (JP)

(72) Inventors: Toshikatsu KURAMOCHI, Tokyo (JP); Sohei HAYASHI, Wako-shi (JP); Suguru ISHIDA, Wako-shi (JP); Junya ONO, Wako-shi (JP); Kenichiro NAKAMURA, Wako-shi (JP); Masaki MARUYAMA, Wako-shi (JP); Masahiro YOSHINO, Wako-shi (JP); Takamasa UDAGAWA, Wako-shi (JP)

(21) Appl. No.: 16/692,311

(22) Filed: Nov. 22, 2019

(30) Foreign Application Priority Data
Nov. 27, 2018 (JP) 2018-221660

(51) Int. Cl. G07B 15/06; G08G 1/081; G06Q 20/32; G06Q 20/22; G06Q 20/06; G06Q 20/14; G05B 19/042

(52) U.S. Cl. CPC G07B 15/063; G08G 1/081; G06Q 20/3223; G06Q 20/29; G05B 2219/23154; G06Q 20/14; G05B 19/042; G06Q 2240/00; G06Q 20/065

(57) ABSTRACT

An information processing apparatus that is for controlling lighting of a traffic light, comprising: a communication circuit configured to acquire information of a transaction condition relating to priority passage from a communication apparatus; one or more processors; and a memory storing instructions which, when the instructions are executed by the one or more processors, cause the information processing apparatus to function as: a control unit configured to control lighting of the traffic light according to the transaction condition on priority passage being satisfied; and a processing unit configured to process a payment of a fee based on the transaction condition on priority passage, wherein the processing unit, in a case where lighting of the traffic light has been controlled, processes the payment of the fee so as to collect a fee for priority passage.

### CROSS-REFERENCE TO RELATED APPLICATION(S)

This application claims priority to and the benefit of Japanese Patent Application No. 2018-221660 filed on Nov. 27, 2018, the entire disclosure of which is incorporated herein by reference.

### BACKGROUND OF THE INVENTION

### Field of the Invention

The present invention relates to information processing apparatus, a method for controlling an information processing apparatus, a communication apparatus, a method for controlling a communication apparatus, and a storage medium for priority passage in accompaniment of a fee.

### Description of the Related Art

In recent years, development of vehicles having an autonomous driving function has advanced, and autonomous vehicle control that does not require the intervention of manual driving by a driver has been realized. It is expected that when many vehicles travel by an autonomous driving function, for example, multiple vehicles will be able to travel in a coordinated manner at a constant speed, and travel control with higher power efficiency (or fuel efficiency) will be realized. Meanwhile, there is the need to perform travel control so as to, upon payment of some fee, shorten travel times in accordance with the convenience of the user by departing from the coordinated travel, or to further increase power efficiency.

Japanese Patent Laid-Open No. 2007-293626 proposes a technique for determining whether or not at least one of a safe operation and an environmentally-friendly operation is being performed, and assigning points according to the result of the determination that such operations are being performed.

However, Japanese Patent Laid-Open No. 2007-293626 does not consider a technique for acquiring a priority passage by paying a fee in order to shorten the travel time when a vehicle passes along a predetermined road, or for realizing more efficient travel by paying a fee.

### SUMMARY OF THE INVENTION

The present disclosure has been made in consideration of the aforementioned issues, and realizes a technique by which it is possible to acquire priority passage by paying a fee when a vehicle passes along a predetermined road.

In order to solve the aforementioned problems, one aspect of the present disclosure provides an information processing apparatus that is for controlling lighting of a traffic light, the apparatus comprising: a communication circuit configured to acquire information of a transaction condition relating to priority passage from a communication apparatus associated with a vehicle within a predetermined distance of the traffic light; one or more processors; and a memory storing instructions which, when the instructions are executed by the one or more processors, cause the information processing apparatus to function as: a control unit configured to control lighting of the traffic light according to the transaction condition on priority passage being satisfied, based on the information of the transaction condition; and a processing unit configured to process a payment of a fee based on the transaction condition on priority passage, wherein the processing unit, in a case where lighting of the traffic light has been controlled by the control unit, processes the payment of the fee so as to collect a fee for priority passage from a party on behalf of a vehicle for which priority passage became possible.

Another aspect of the present disclosure provides, a communication apparatus that is for communicating with an information processing apparatus for controlling lighting of a traffic light and that is associated with a vehicle, the communication apparatus comprising: a communication circuit that, for passage controlled by lighting of the traffic light, transmits to the information processing apparatus information of a transaction condition relating to priority passage; one or more processors; and a memory storing instructions which, when the instructions are executed by the one or more processors, cause the communication apparatus to function as: a control unit configured to cause the vehicle to perform priority passage of a location where passage is controlled by the traffic light in accordance with priority passage becoming possible based on information of the transaction condition by the information processing apparatus; and a processing unit configured to process a payment of a fee based on the transaction condition on priority passage, wherein the processing unit, in a case where the vehicle is caused to perform priority passage of the location where passage is controlled by the traffic light, processes payment of a fee for priority passage so that the fee is paid.

Still another aspect of the present disclosure provides, a method for controlling an information processing apparatus that is for controlling lighting of a traffic light, the method comprising: acquiring information of a transaction condition relating to priority passage from a communication apparatus associated with a vehicle within a predetermined distance of the traffic light; controlling lighting of the traffic light according to the transaction condition on priority passage being satisfied, based on the information of the transaction condition; and processing a payment of a fee based on the transaction condition on priority passage, wherein in the processing step, in a case where lighting of the traffic light has been controlled in the control step, processes the payment of the fee so as to collect a fee for priority passage from a party on behalf of a vehicle for which priority passage became possible.

Yet another aspect of the present disclosure provides, a method for controlling a communication apparatus that is for communicating with an information processing apparatus for controlling lighting of a traffic light and that is associated with a vehicle, the communication apparatus comprising: for passage controlled by lighting of the traffic light, transmitting, to the information processing apparatus, information of a transaction condition relating to priority passage; causing the vehicle to perform priority passage of a location where passage is controlled by the traffic light in accordance with priority passage becoming possible based on information of the transaction condition by the information processing apparatus; and processing a payment of a fee based on a transaction condition relating to priority passage, wherein in the processing step, payment of a fee for priority passage is processed so as to pay the fee in a case where the vehicle is caused to perform priority passage of the location where passage is controlled by the traffic light.

Still yet another aspect of the present disclosure provides, a non-transitory computer-readable storage medium storing a program that is for causing a computer to function as each unit of a communication apparatus, wherein the communication apparatus is associated with a vehicle and communicates with an information processing apparatus for controlling lighting of a traffic light, and comprises: a communication unit configured to, for passage controlled by lighting of the traffic light, transmit to the information processing apparatus information of a transaction condition relating to priority passage; a control unit configured to cause the vehicle to perform priority passage of a location where passage is controlled by the traffic light in accordance with priority passage becoming possible based on information of the transaction condition by the information processing apparatus; and a processing unit configured to process a payment of a fee based on the transaction condition on priority passage, wherein the processing unit, in a case where the vehicle is caused to perform priority passage of the location where passage is controlled by the traffic light, processes payment of a fee for priority passage so that the fee is paid.

According to the present invention, a technique by which it is possible to realize enabling the acquisition of priority passage by the payment of a fee when a vehicle passes along a predetermined road.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1A is a diagram illustrating an example of a traffic system according to a first embodiment of the present invention.

FIG. 1B is a diagram for explaining examples of route setting user interfaces when using the traffic system according to the first embodiment.

FIG. 2 is a block diagram illustrating an example of a functional configuration of an information processing apparatus according to the first embodiment.

FIG. 3 is a block diagram illustrating an example of a functional configuration of a communication apparatus according to the first embodiment.

FIG. 4 is a block diagram illustrating an example of a functional configuration of a navigation information processing server according to the first embodiment.

FIG. 5 is a flowchart illustrating a series of operations of a lighting control process in the information processing apparatus according to the first embodiment.

FIG. 6 is a flowchart illustrating a series of operations of a transaction condition determination process in the information processing apparatus according to the first embodiment.

FIG. 7AA to FIG. 7AB are diagrams illustrating an example of a transaction condition determination process according to the first embodiment.

FIG. 7BA to FIG. 7BB are diagrams illustrating an example of a fee payment process according to the first embodiment.

FIG. 8A to FIG. 8B are diagrams illustrating an example of a transaction condition determination process according to the first embodiment.

FIG. 9 is a flowchart illustrating a series of operations of a vehicle control process in the communication apparatus according to the first embodiment.

FIG. 10 is a diagram illustrating an example of a traffic system according to a second embodiment.

FIG. 11 is a block diagram illustrating an example of a functional configuration of the communication apparatus according to the second embodiment.

FIG. 12 is a flowchart illustrating a series of operations of a vehicle control process in the communication apparatus according to the second embodiment.

FIG. 13A to FIG. 13B are diagrams illustrating an example of priority passage of a vehicle according to the second embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

Exemplary embodiments of the present invention will be explained hereinafter in detail, with reference to the drawings. The first embodiment describes an example of a traffic system that controls traffic lights to control priority passage of a vehicle passing through an intersection.

<Configuration of Traffic System>

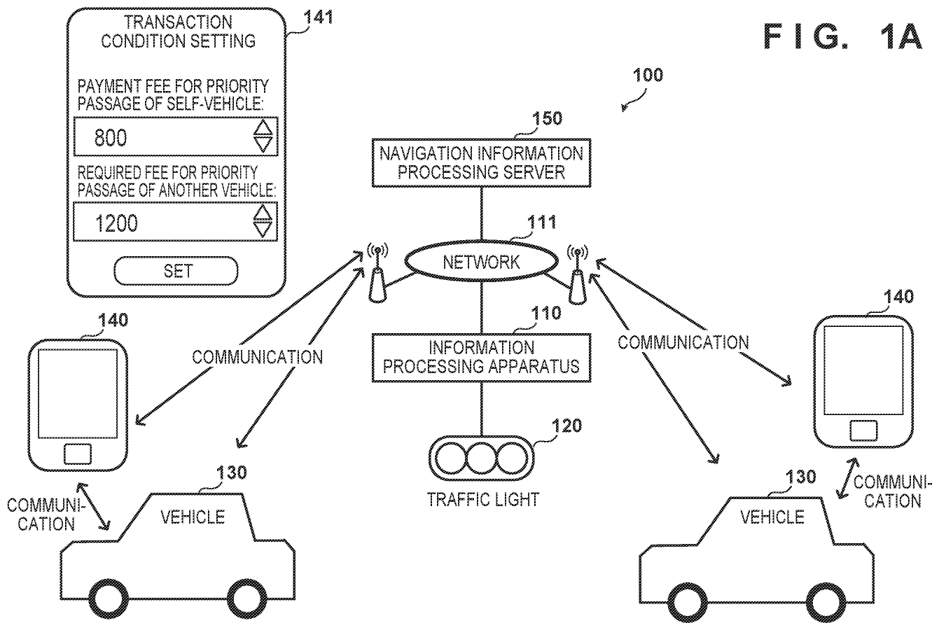

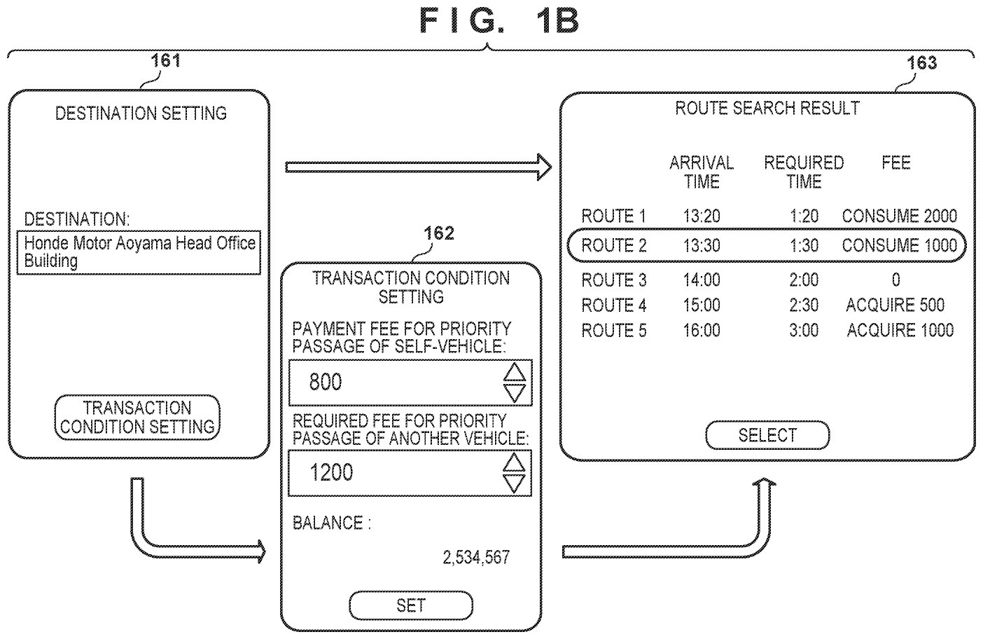

Referring to FIG. 1A, the configuration of a traffic system 100 according to the present embodiment will be described. A vehicle 130 is, for example, a vehicle capable of traveling using fuel or an electric vehicle capable of automated driving travel. The vehicle 130 can measure states in the vehicle by various sensors in the vehicle, and can transmit the collected data to a navigation information processing server 150. The data collected and transmitted in this manner is generally referred to as floating data, probe data, traffic information, and the like. Such data may include, for example, the current position, the velocity of the vehicle, the remaining capacity of a battery or fuel in the vehicle, an image obtained by a camera or LIDAR, three-dimensional data, etc., but may also include other information. These data are transmitted to a navigation information processing server 150 at regular intervals or in response to the occurrence of a specific event. In addition, the vehicle 130 also transmits, to the navigation information processing server 150, setting information such as a destination and a way point set by the user, and a transaction condition relating to priority passage, which will be described later. In the following description, data transmitted from the vehicle 130 to the navigation information processing server 150 is collectively referred to as vehicle information. Vehicle information, some or all of which is associated with the vehicle 130, may also be transmitted as necessary to a communication apparatus 140. In the following example, the case where the communication apparatus 140 is, for example, a smartphone is described as an example, but the invention is not limited to this, and the communication apparatus 140 may be an in-vehicle apparatus incorporated in the vehicle 130, or may be a personal computer, a tablet terminal, or the like.

The navigation information processing server 150 is configured by one or more server apparatuses, and sequentially acquires vehicle information from a plurality of vehicles 130 and records the vehicle information in a vehicle database. In addition, information of a traffic light 120 (from an information processing apparatus 110) is also sequentially acquired, and traffic conditions of various routes can be ascertained substantially in real time thereby. Using the acquired information, the navigation information processing server 150 can estimate, for example, a route along which the vehicle passes, a time required for passage, and a fee to be paid and received before arrival at a destination. The navigation information processing server 150 (which will be described later with reference to FIG. 1B) can transmit an estimated route and fee to the communication apparatus 140 in response to a request therefor. When the user selects a desired route, the selected route is set to the vehicle 130, and the vehicle 130 passes along the route by, for example, automated driving. A display 141 is an example of transaction condition settings displayed on a display unit of the communication apparatus 140, and the display 141 illustrates a screen on which fees for priority passage can be set.

An information processing apparatus 110 controls lighting of the traffic light 120. The information processing apparatus 110 can control the lighting of the traffic light 120 so that it switches at a normal lighting timing, and can communicate with communication apparatuses 140 associated with vehicles 130 within a predetermined distance to control the lighting of the traffic light 120 according to transaction conditions relating to priority passage. Control based on transaction conditions relating to priority passage will be described later. In the example of the present embodiment, the case where the traffic light 120 and the information processing apparatus 110 are separate entities is described as an example, but the information processing apparatus 110 may be built into the traffic light 120.

A network 111 may be, for example, a communication network such as the Internet or a mobile network, and the network 111 transmits information between the information processing apparatus 110 and the navigation information processing server 150, and the vehicle 130 and the communication apparatus 140. However, the network 111 is not indispensable, and, for example, the communication apparatus 140 and the information processing apparatus 110 may directly establish wireless communication and perform communication thereby.

The communication apparatus 140 can communicate with the vehicle 130 via wireless communication such as Bluetooth (registered trademark) or the like, and can communicate with the information processing apparatus 110 and the navigation information processing server 150 via the network 111 which may be a mobile communication network. The communication apparatus 140 is associated with the vehicle 130, for example, by being paired with the vehicle 130 in advance.

In order for a user of the vehicle 130 to arrive at a destination utilizing the traffic system 100, a communication apparatus 140 associated with the vehicle 130, for example, is used to determine a route to the destination. FIG. 1B illustrates examples of route setting user interfaces in the communication apparatus 140 of the present embodiment. First, the communication apparatus 140 displays a destination setting screen 161 for setting a destination. The user inputs a destination via an operation unit 303 of the communication apparatus 140, which will be described later. When a transaction condition related to priority passage is set in advance when the destination is input, the communication apparatus 140 transmits the set destination and information on a transaction condition relating to priority passage to the navigation information processing server 150. In the following description, there are cases where a transaction condition relating to priority passage is simply referred to as a “transaction condition” and information of a transaction condition relating to priority passage is simply referred to as “transaction condition information”.

Meanwhile, when the transaction condition is not set, the communication apparatus 140 displays a transaction condition setting screen 162. The transaction condition setting screen 162 is a screen for setting a transaction condition, and, for example, it is possible to set a fee to be paid to another vehicle in a case where the self-vehicle is caused to pass with priority, and a fee required for priority passage of another vehicle in a case where priority passage of another vehicle is accepted. For example, suppose there is a situation in which the self-vehicle is approaching an intersection and stopping for a red light, and meanwhile, there is another vehicle that will pass along the intersecting road on a green light. At this time, the “a fee to be paid when the self-vehicle is caused to perform priority passage” represents a fee that may be paid for the purpose of shortening the travel time to arrive at the destination early or the like. That is, in the example of the intersection, a transaction is made to cause the other vehicle to stop by a red light, and cause the self-vehicle to pass by a green light. Conversely, the “a fee required for priority passage of another vehicle” represents a fee required to be received in exchange for extending the travel time. That is, in the example of the intersection, it represents requiring a set fee for stopping at a red light when requested by the other vehicle to accept its priority passage in the case where the self-vehicle is about to pass on a green light. When the fees are decided on the transaction condition setting screen 162, the communication apparatus 140 transmits the fees to the navigation information processing server 150 as information of transaction conditions relating to priority passage. At this time, destination information is also transmitted.

In the example illustrated in FIG. 1B, an example is illustrated in which the amounts of the fees are set using a virtual currency for “a fee to be paid when the self-vehicle is caused to perform priority passage” and “a fee required for priority passage of another vehicle”. However, the amounts of fees may be represented, for example, by amounts converted into the currency of the home country. If the amounts of the fees are, for example, amounts corresponding to an income per hour, the buying and selling of time can be expressed in a realistic and intuitive scale. In addition, the length of time for which the waiting time can be allowed may be set for the “fee required for priority passage of another vehicle”. In this manner, in the transaction condition setting, it is possible to set how much value can be paid for the travel time.

The navigation information processing server 150 returns route search results for the vehicle 130 considering the current traffic conditions, the route to the destination of the other vehicle, and transaction conditions. The communication apparatus 140 displays the received route search results on a route search result screen 163. The display of the route search result screen 163 includes a plurality of route candidates such as “route 1” to “route 6”. Each route includes an arrival time and a required time which are estimated by the navigation information processing server 150. In addition, a fee is displayed as a candidate for each route. This fee is a fee to be obtained before arriving at the destination. If more other vehicles are accepted for priority passage, more fees will be acquired, and the more vehicles the self-vehicle passes with priority over other vehicles, the more payments will be incurred. The fee may be exchanged with a currency, and, for example, the fee calculation and transaction may be performed using a virtual currency. Note that the transaction condition setting is not limited to the case of setting a route, and may be changed while the vehicle is traveling.

<Configuration of Information Processing Apparatus>

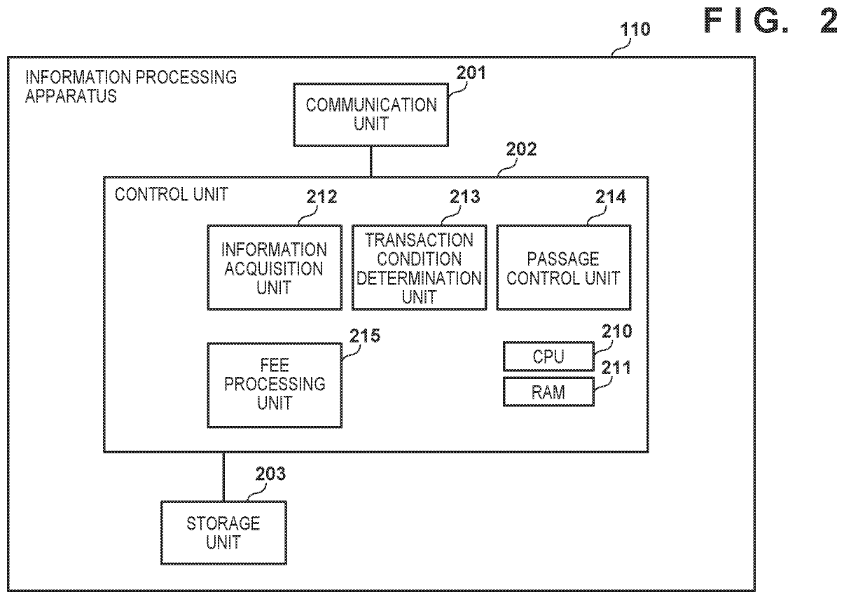

Next, an example of a functional configuration of the information processing apparatus 110 for controlling lighting of a signal will be described with reference to FIG. 2. It should be noted that each of the functional blocks described may be integrated or separated, and the functions described may be implemented in separate blocks. Also, what is described as hardware may be implemented in software, or vice versa.

A communication unit 201 includes a communication circuit that communicates with a plurality of communication apparatuses 140 via the network 111. Information processed by a control unit 202 is transmitted to the communication apparatus 140 or the like, and information to be processed by the control unit 202 is received from the communication apparatus 140 or the like.

The control unit 202 includes a CPU 210 that is a central processing unit, and a RAM 211. The control unit 202 loads into the RAM 211 and executes programs stored in a storage unit 203, thereby controlling the operation of each unit inside the control unit 202 and controlling the operation of each unit of the information processing apparatus 110. In addition, the control unit 202 executes a process for controlling lighting of the traffic light 120. This lighting control process will be described later. The RAM 211 includes, for example, a volatile storage medium such as a DRAM, and temporarily stores parameters for executing programs by the control unit 202, process results, and the like. The storage unit 203 includes, for example, a nonvolatile recording medium such as a semiconductor memory, and stores setting values and programs necessary for the operation of the information processing apparatus 110.

An information acquisition unit 212 first identifies processing target vehicles among vehicles passing in the vicinity of the traffic light 120 (e.g., within a predetermined distance therefrom), and acquires information on the transaction conditions from the communication apparatuses 140 associated with the vehicles. A transaction condition determination unit 213 determines whether or not a transaction condition relating to priority passage is satisfied based on information of the transaction conditions acquired from one or more communication apparatuses 140.

A passage control unit 214 controls lighting of the traffic light 120 in accordance with a determination result in the transaction condition determination unit 213 (that is, whether or not a transaction condition relating to priority passage has been satisfied). When lighting of the traffic light is controlled based on the determination result by the transaction condition determination unit 213, a fee processing unit 215 processes the payment of the fee based on the satisfied transaction condition (that is, finalizes the fee to be paid by the vehicle), and transmits the information of the finalized fee to the communication apparatus 140.

<Configuration of Communication Apparatus>

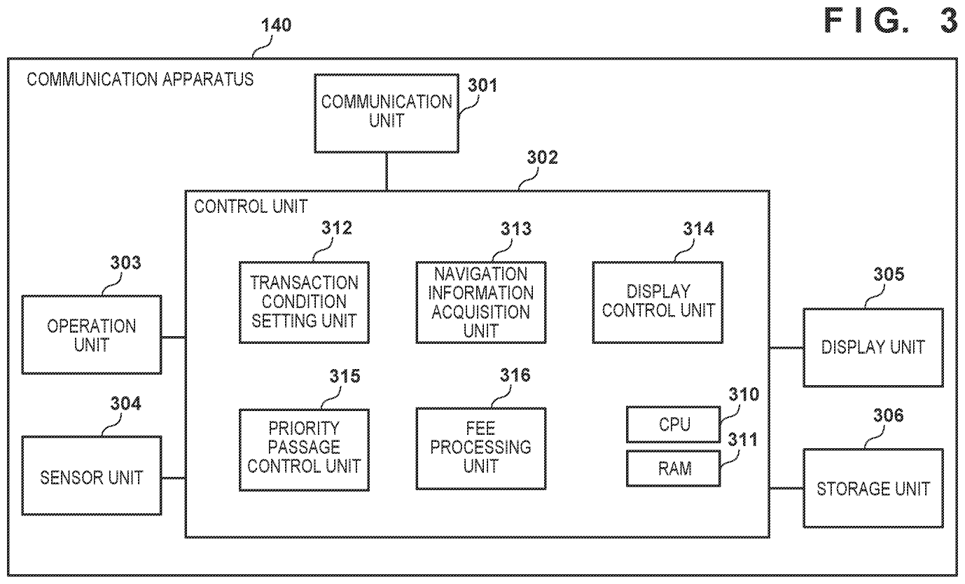

Next, a configuration example of the communication apparatus 140 will be described with reference to FIG. 3. The configuration illustrated in FIG. 3 illustrates functional blocks configuring a smartphone as an example of the communication apparatus 140 of the present embodiment. It should be noted that each of the functional blocks described may be integrated or separated, and the functions described may be implemented in separate blocks. Also, what is described as hardware may be implemented in software, or vice versa.

The communication unit 301 includes, for example, a communication circuit and the like, and performs transmission and reception of required data by connecting to the Internet via mobile communication such as LTE or connecting to the vehicle 130 via Bluetooth (registered trademark) communication.

An operation unit 303 includes buttons and a touch panel included in the communication apparatus 140, and it is possible to perform operations on GUIs for various operations such as the destination setting screen 161 and the transaction condition setting screen 162 displayed on the display unit 305. The display unit 305 includes, for example, a display panel such as an LCD or an OLED, and displays GUIs for various operations such as the destination setting screen 161 and the transaction condition setting screen 162, GUIs by which it is possible to confirm a route during travel, and the like in accordance with an instruction from a display control unit 314. A sensor unit 304 includes a sensor for biometric authentication for identifying the user of the communication apparatus 140, in addition to a GPS for identifying a current position.

The storage unit 306 includes, for example, a nonvolatile memory such as a semiconductor memory, and stores map information, information on set transaction conditions, a program executed by the control unit 302, and the like. The storage unit 306 holds data of a distributed ledger used in, for example, a blockchain technique. In the present embodiment, a transaction using a virtual currency based on the fee notified from the information processing apparatus 110 is recorded in the distributed ledger. For example, the communication apparatus 140 functions as one node for managing the distributed ledger, and the program executed by the control unit 302 may include a program for processing a transaction using a virtual currency, managing the distributed ledger, or a program of a smart contract.

The control unit 302 includes a CPU 310 and a RAM 311, and for example, the CPU 310 executes programs stored in the storage unit 306 to control the respective functional blocks in the control unit 302 and the operations of the respective units in the communication apparatus 140.

A transaction condition setting unit 312 sets information of a transaction condition based on user operation in relation to the above-described transaction condition setting screen 162. The transaction condition setting unit 312 stores information of a set transaction condition in the storage unit 306, and transmits the information to the navigation information processing server 150 and peripheral information processing apparatuses 110 via the communication unit 301. A navigation information acquisition unit 313 acquires information of route search results from the navigation information processing server 150.

The display control unit 314 controls the display of the display unit 305 so as to display a GUI for various operations such as the destination setting screen 161 and the transaction condition setting screen 162, a GUI by which it is possible to confirm a route during traveling, and the like. The display control unit 314 displays the destination setting screen 161 and the route search result screen 163 on the display unit 305 based on, for example, user operation and information of the route search results received from the navigation information processing server 150.

In a case where lighting of the traffic light 120 is controlled by the information processing apparatus 110, a priority passage control unit 315 receives a passage possible notification (i.e., a notification indicating that priority passage has become possible) or a passage impossible notification (a notification indicating that priority passage of another vehicle was accepted) from the information processing apparatus 110. In response to receiving these notifications, the priority passage control unit 315 transmits to the vehicle 130 a control signal for passing through the intersection with priority or for stopping.

A fee processing unit 316 receives finalized fee information from the information processing apparatus 110. The fee processing unit 316 performs a fee transaction based on the finalized fee information, and records the transaction in the distributed ledger.

<Configuration of Navigation Information Processing Server>

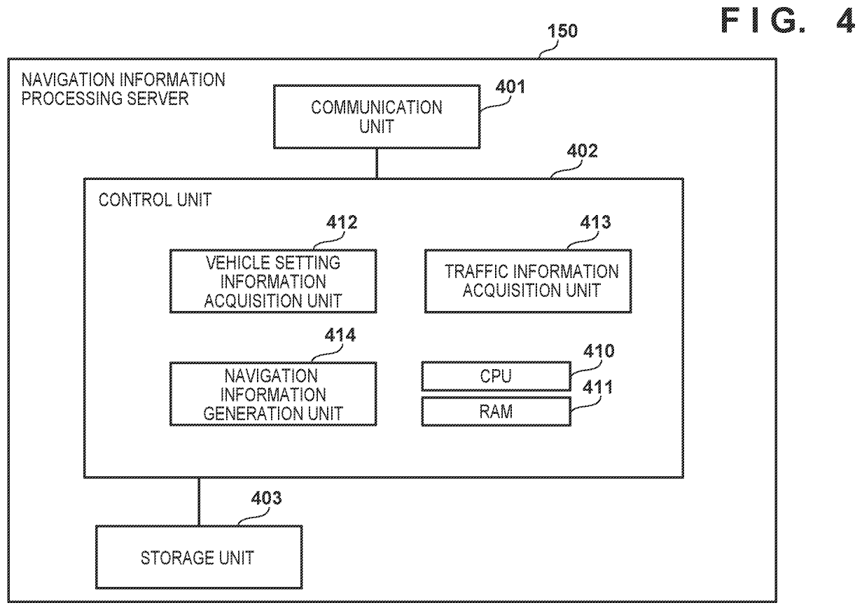

The configuration of the navigation information processing server 150 according to the present embodiment will now be described with reference to FIG. 4. The navigation information processing server 150 is configured by one or more server apparatuses. It should be noted that each of the functional blocks described may be integrated or separated, and the functions described may be implemented in separate blocks. Also, what is described as hardware may be implemented in software, or vice versa.

A communication unit 401 includes a communication circuit that communicates with the communication apparatuses 140 and the vehicle 130 via the network 111. Information processed by a control unit 402 is transmitted to the communication apparatus 140 or the like, and information to be processed by the control unit 402 is received from the communication apparatus 140 or the like.

The control unit 402 includes a central processing unit (CPU 410) and a RAM 411. The control unit 402 loads into the RAM 411 and executes programs stored in a storage unit 403, thereby controlling the operation of each unit inside the control unit 402 and controlling the operation of each unit of the navigation information processing server 150. In addition, the control unit 402 executes a route search process for generating the route search results illustrated in FIG. 1B. The RAM 411 includes, for example, a volatile storage medium such as a DRAM, and temporarily stores parameters for executing programs by the control unit 402, process results, and the like. The storage unit 403 includes, for example, a nonvolatile recording medium such as a semiconductor memory, and stores setting values and programs necessary for the operation of the navigation information processing server 150.

The storage unit 403 includes, for example, a nonvolatile memory such as a semiconductor memory, and stores an application program executed by the communication apparatus 140, data used by the program, or the like.

A vehicle setting information acquisition unit 412 receives the above-described vehicle information (i.e., information on the current position and the vehicle speed, information on the destination, information on the transaction conditions, and the like) from the plurality of vehicles 130, and records the vehicle information in a vehicle database. In addition, the vehicle setting information acquisition unit 412 receives search request information (current location, destination for route search, and transaction condition information) from the communication apparatus 140.

A traffic information acquisition unit 413 sequentially acquires information of the traffic light 120 (e.g., information of a lighting status and a lighting timing of the traffic light) from the information processing apparatus 110 of the traffic light located at various points.

A navigation information generation unit 414 generates a route search result with respect to information of the search request from the communication apparatus 140. For example, the navigation information generation unit 414 determines a predetermined number of route candidates having a small route cost from the current location to the destination, and then calculates the fees to be paid and the fees to be received while determining the information of the transaction conditions of other vehicles scheduled to approach within a predetermined distance when passing through each route candidate and the information of the transaction conditions included in the search request. The navigation information generation unit 414 also calculates a travel time that fluctuates depending on payment or reception of fees. In addition, the route candidates may be modified so as to stop at a charging or refueling facility in the vicinity of a point where charging or refueling will be required. The navigation information generation unit 414 sorts the calculated route candidates, for example, in the order of required time, and transmits the route candidates to the communication apparatus 140 as search result information. The search result information includes information on a route, an arrival time, a required time, and fees, as illustrated in the route search result screen 163 of the above-described FIG. 1B.

<Series of Operations of the Lighting Control Process (of the Traffic Light) in the Information Processing Apparatus 110>

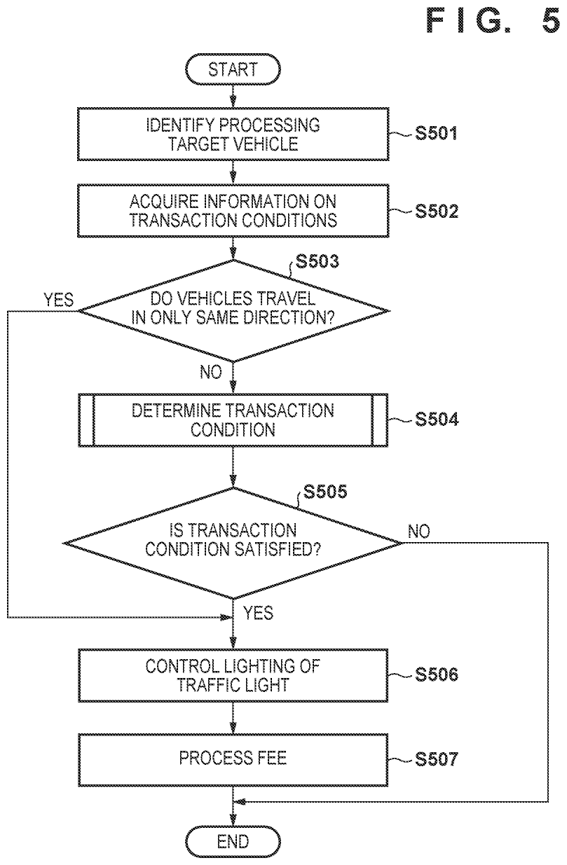

Next, a series of operations of lighting control processes in the information processing apparatus 110 will be described next with reference to FIG. 5. This process is realized by the CPU 210 of the control unit 202 executing a program stored in the storage unit 203.

In step S501, the control unit 202 identifies processing target vehicles from vehicles passing in the vicinity of the traffic light 120 (for example, within a predetermined range). For example, the control unit 202 acquires a current position, moving direction, and vehicle speed of the vehicle from the communication apparatus 140 associated with vehicles passing in the vicinity of the traffic light 120, and determines whether the vehicle will be affected by the lighting of the traffic light (i.e., whether it is a processing target vehicle). Vehicles that will stop at a red light of the traffic light and vehicles that will pass on a green light are identified as vehicles that will be affected by lighting.

In step S502, the information acquisition unit 212 of the control unit 202 obtains information on transaction conditions of the communication apparatuses 140 associated with the processing target vehicles from the communication apparatuses 140.

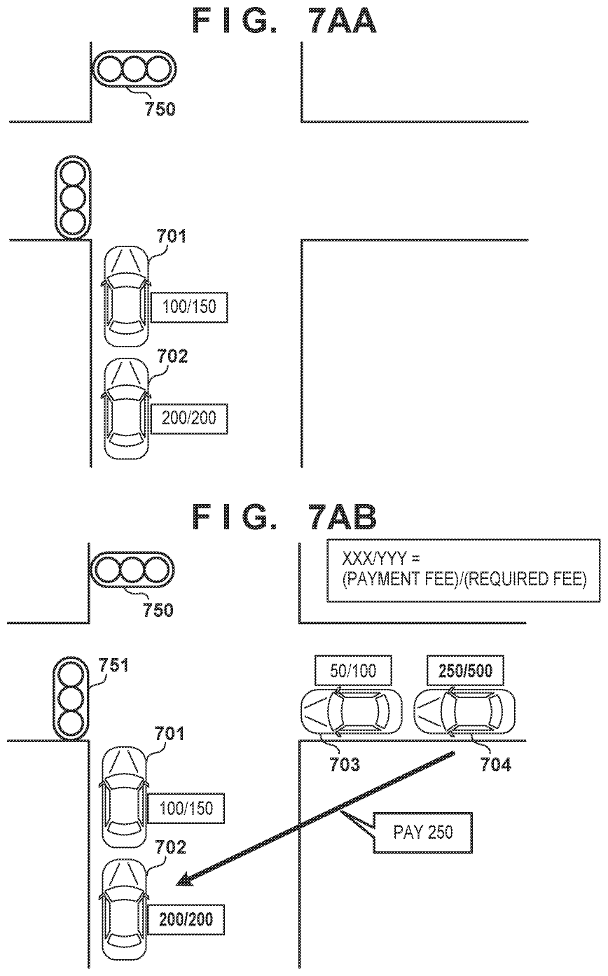

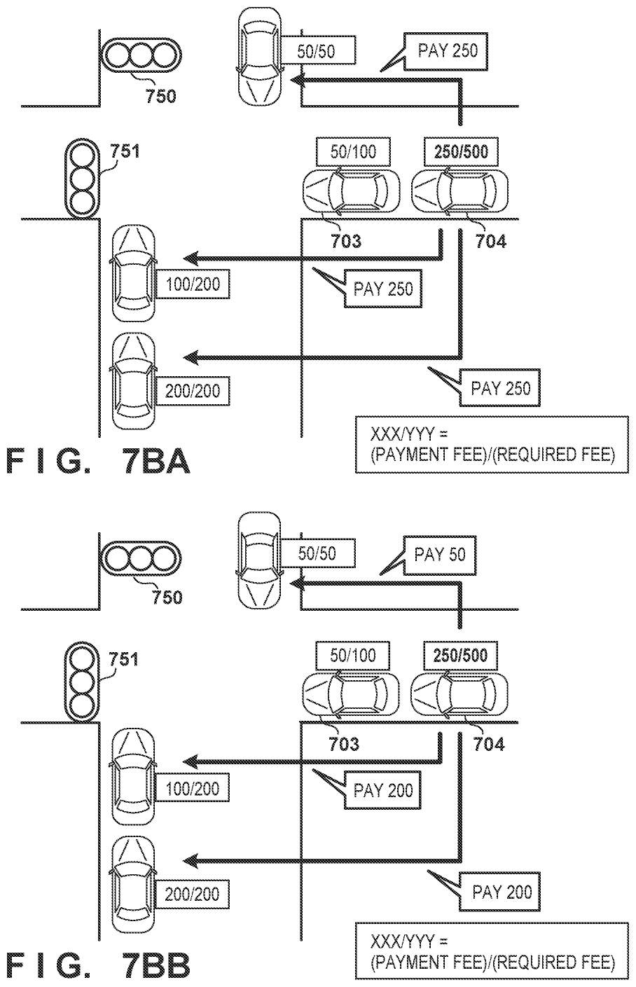

In step S503, the transaction condition determination unit 213 determines whether or not the vehicles specified as the processing targets travel only in the same direction. Specifically, in the example illustrated in FIG. 7AA, only the vehicle 701 and the vehicle 702 (i.e., the processing target vehicle) are approaching the intersection, and the vehicle 701 and the vehicle 702 are travelling only in the same direction. When only the vehicles passing in the same direction are approaching the intersection in this manner, it is not necessary to stop a vehicle by setting the traffic light 750 to a red light. That is, if, when the traffic light 750 is red, the lighting of the traffic light 750 is controlled to be a green light to cause these vehicles to pass through, the vehicles can arrive at their destinations earlier. In the same-direction determination, when there is an oncoming vehicle with respect to the vehicle 701 and the vehicle 702, the oncoming vehicle can be regarded as a vehicle that will travel only in the same direction. Also, when there is only one processing target vehicle, it may be handled in the same manner.

For example, when the transaction condition determination unit 213 determines that the vehicles specified as processing targets will pass in the same direction based on the current positions, moving directions, and vehicle speeds of the vehicles from the communication apparatus 140, the processing proceeds to step S506. Otherwise, the processing proceeds to step S504.

In step S504, the transaction condition determination unit 213 determines whether or not a transaction condition relating to priority passage is satisfied based on transaction condition information received from the processing target vehicles. Details of the transaction condition determination processing will be described later separately.

In step S505, the control unit 202 proceeds to step S506 when the transaction condition is satisfied in step S504, and ends this series of processes when the transaction condition is not satisfied. For example, the control unit 202 determines whether or not a transaction condition is satisfied with reference to a flag value indicating a determination result, which will be described later.

In step S506, the passage control unit 214 of the control unit 202 controls lighting of the traffic light. The passage control unit 214 controls the lighting of the traffic light 120 on one road from a red light to a green light so that the vehicle that pays the fee can pass through the intersection. At this time, in response to controlling the lighting of the traffic light 120, the passage control unit 214 may transmit a passage possible notification to the communication apparatus 140 of the vehicle that has been caused to perform priority passage. At this time, a passage impossible notification may be transmitted to the communication apparatus 140 of the vehicle that has accepted the priority passage of the other vehicle.

In step S507, the fee processing unit 215 processes payment of the fee based on the transaction condition (that is, finalizes the fee to be paid by the vehicle), and transmits information of the finalized fee to the communication apparatus 140. Determination of the transaction condition by the transaction condition determination unit 213 and processing of the fee by the fee processing unit 215 will be described in more detail below.

<Series of Operations of Transaction Determination Processing>

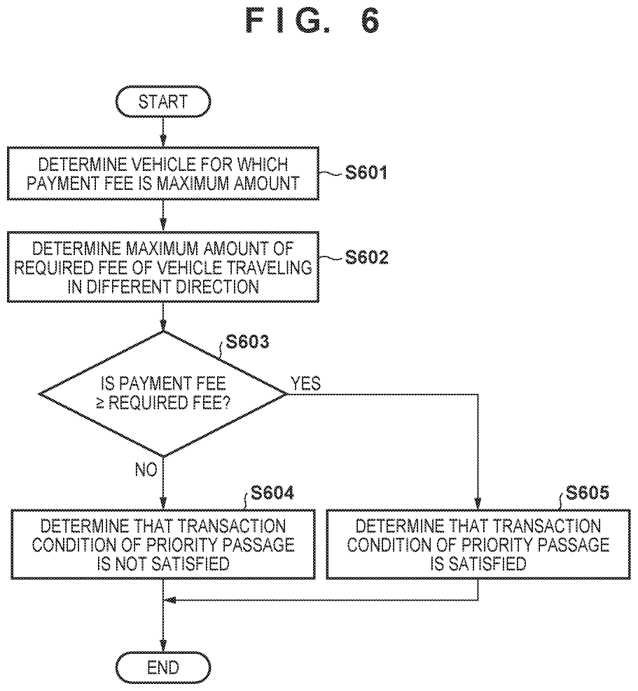

Next, a series of operations of the transaction determination processing of step S504 will be described with reference to FIG. 6. This process continues from the processing of FIG. 5 and is realized by the CPU 210 of the control unit 202 executing a program stored in the storage unit 203.

In step S601, the transaction condition determination unit 213 determines a vehicle for which a fee (payment fee) to be paid in the case where priority passage is caused is a maximum amount. For example, based on information of the transaction conditions of each vehicle, the vehicle for which the payment fee is the maximum amount is determined. For example, in the example illustrated in FIG. 7AB, the vehicles 701 to 702 and the vehicles 703 to 704 are approaching the intersection while passing in respectively different directions. At this time, the traffic light 750 is on a green light, and the traffic light 751 is on a red light. In this situation, the transaction condition determination unit 213 compares the payment fees for the vehicles 701 to 704, and determines that the vehicle with the highest payment fee is the vehicle 704 (payment fee is 250).

In step S602, the transaction condition determination unit 213 determines the maximum fee amount (required fee) required for priority passage for vehicles that will pass in a direction other than the direction of the vehicle determined in step S601. In the example of FIG. 7AB, among the vehicles 701 to 702 that will pass in a different direction to the vehicle 704, the maximum amount of the required fee is 200 of the vehicle 702. When there is an oncoming vehicle, it may be considered as a vehicle of the same direction.

In step S603, the transaction condition determination unit 213 determines whether or not the payment fee (that is, a maximum payment fee amount) of the vehicle determined in step S601 is greater than or equal to the required fee (the maximum amount of the required fee) determined in step S602. If it is determined that the payment fee is greater than or equal to than the required fee, the transaction condition determination unit 213 proceeds to step S605, and if not, proceeds to step S604.

In step S604, when the maximum amount of the payment fee falls below the required fee, the transaction condition determination unit 213 determines that the transaction condition relating to priority passage has not been satisfied, and sets a flag value indicating the determination result to 0 indicating the transaction condition NG.

Meanwhile, in step S605, when the payment fee is greater than or equal to the required fee, the transaction condition determination unit 213 determines that the transaction condition relating to priority passage has been satisfied, and sets a flag value indicating the determination result to 1 indicating the transaction condition OK. Thereafter, the transaction condition determination unit 213 returns to a call source.

<Processing of Fee in Step S507>

Next, the processing of the fee in step S507 will be described by referring to FIG. 7AA to FIG. 7AB and FIG. 7BA to FIG. 7BB. As described above, FIG. 7AA illustrates an example in which the vehicles travel only in the same direction. In this case, the traffic light is controlled so that the vehicles can pass, and the fee processing unit 215 processes the payment of fees so that a fee is not paid from the vehicles 701 to 702 for the priority passage. This reduces waiting for a signal unnecessarily and makes it easier to use the system because it does not require payment of fees, which can be expected to encourage fast adoption of the system. Meanwhile, configuration may be such that even when the vehicles travel only in the same direction, if the lighting of the traffic light is controlled to be a green light, a payment fee is paid for the reduction of the waiting time.

Also, the example illustrated in FIG. 7AB illustrates a case where the transaction condition is satisfied between vehicles passing in different directions. In this case, the transaction condition determination unit 213 finalizes the fees so that the fee 250 is paid from the vehicle 704, in which the maximum amount of the payment fee is set, to the vehicle 702, in which the maximum amount of the required fee (of the vehicles in a different direction) is set.

Of course, the fee processing when the transaction condition is satisfied between vehicles passing in different directions is not limited to this. For example, payments may be processed in a one-to-many relationship, as illustrated in FIG. 7BA and 7BB. In the example of FIG. 7BA, the transaction condition determination unit 213 controls so that a payment fee 250 is paid to each of a plurality of vehicles that have accepted priority passage of the vehicle 704 from the vehicle 704 that has set the maximum amount of the payment fee. Meanwhile, in the example of FIG. 7BB, the transaction condition determination unit 213 controls so that a required fee amount of each vehicle is paid to each of the plurality of vehicles that have accepted priority passage of the vehicle 704 from the vehicle 704 that has set the maximum amount of the payment fee.

Further, in the above-described example, cases where only one vehicle pays the fee has been described as examples, but the payment of fees may be set so as to be many-to-many. That is, the sum of the fees paid from the plurality of vehicles that have been caused to perform priority passage may be distributed to the plurality of vehicles that have accepted the priority passage.

As described above, in the lighting control process in the information processing apparatus 110, information of transaction conditions is acquired from the communication apparatuses 140 associated with the processing target vehicles, and the transaction conditions are judged according to the relationship between the maximum amounts of the payment fee and the required fee of the information of the transaction conditions, and the fee is processed. By doing so, it becomes possible to pay fees for shortening travel time or to receive fees in exchange for extending travel time, and it becomes possible to buy and sell the value of travel time in accordance with the convenience of the person himself/herself.

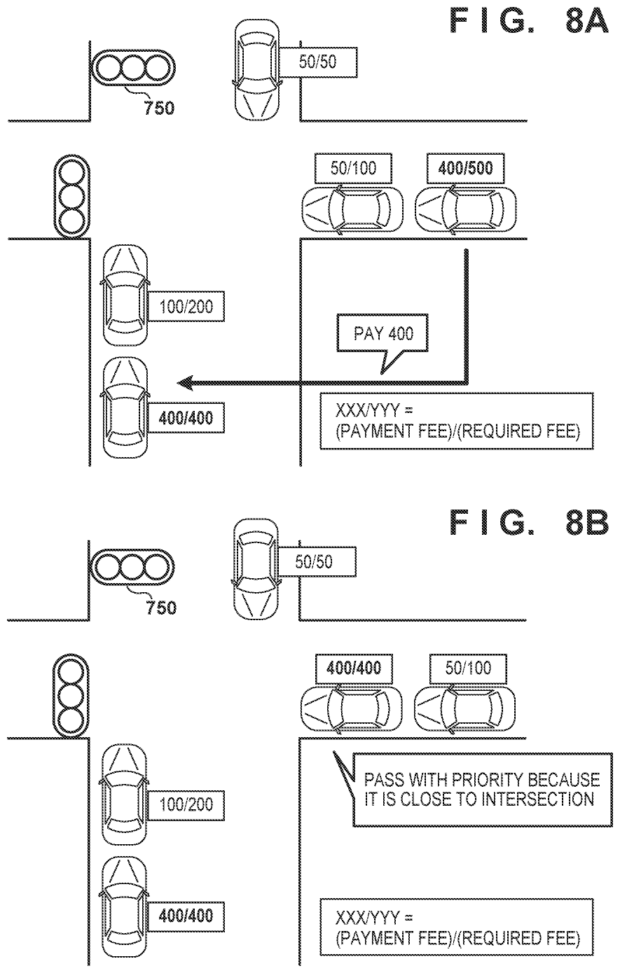

In the lighting control process described above, the maximum payment fee amount is used for the determination of whether or not the transaction condition is satisfied, but another determination may be used. For example, as illustrated in FIG. 8A, it may be determined whether or not the transaction condition is satisfied based on the sum of the payment fee amounts and required fee amounts. In this example, a vehicle having a higher sum of payment fee amount and required fee amount is caused to perform priority passage. It is considered that a person who sets a higher payment fee and a higher reception fee has a higher desire to pass with priority. Therefore, if the sum of the payment fee amount and the required fee amount is used, it is possible to control according to the degree to which the user desires to pass with priority. Further, when sums of the payment fee amount and the required fee amount are the same, the transaction condition may be determined according to the distance from the intersection to the vehicle. In this manner, when settlement cannot be made by the transaction condition, it is possible to prioritize a vehicle which is expected to exit the intersection earlier.

<Series of Operations in Communication Control Process in the Communication Apparatus 140>

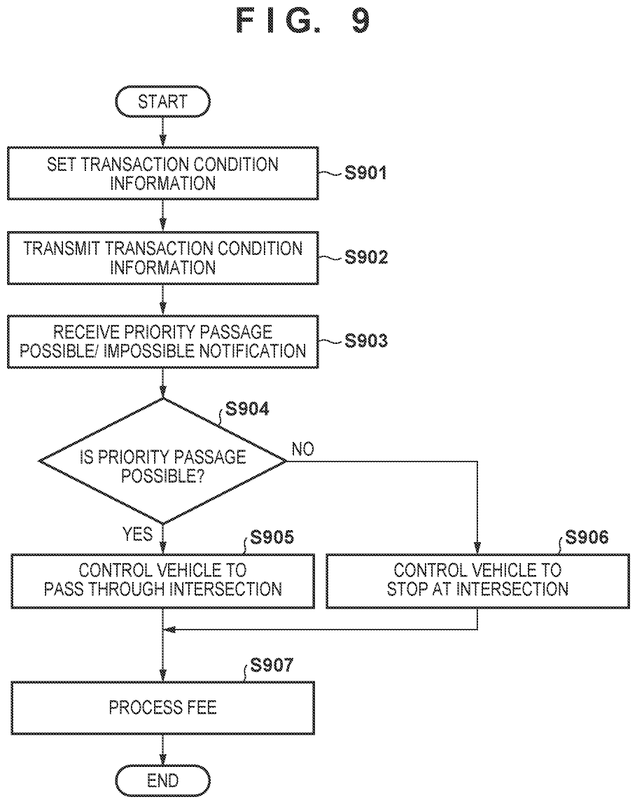

Next, a series of operations of communication control process in the communication apparatus 140 will be described with reference to FIG. 9. This process is realized by the CPU 310 of the control unit 302 executing a program stored in the storage unit 306.

In step S901, the transaction condition setting unit 312 of the control unit 302 sets the information of a transaction condition based on a user operation in relation to the above-described transaction condition setting screen 162. The transaction condition setting unit 312 records the information of the set transaction condition in the storage unit 306.

In step S902, the transaction condition setting unit 312 transmits the transaction condition information to peripheral information processing apparatuses 110 via the communication unit 301. For example, the control unit 302 communicates with peripheral information processing apparatuses 110, and when it is determined from a specific information processing apparatus 110 that the vehicle will be affected by lighting of a traffic light (i.e., processing target vehicle), the control unit 302 transmits information on a transaction condition to that information processing apparatus 110.

In step S903, in a case where lighting of the traffic light 120 is controlled by the information processing apparatus 110, a priority passage control unit 315 receives a passage possible notification (i.e., a notification indicating that priority passage has become possible) or a passage impossible notification (i.e. a notification indicating that priority passage of another vehicle is accepted) from the information processing apparatus 110.

In step S904, the priority passage control unit 315 determines whether the received notification indicates that the priority passage is possible, and if it is determined that the priority passage is possible, the process proceeds to step S905, otherwise, the process proceeds to step S906. In step S905, the priority passage control unit 315 transmits a control signal for passage through the intersection with priority to the vehicle 130 in response to receiving the passage possible notification. Meanwhile, in step S906, the priority passage control unit 315 transmits a control signal, for acceptance of passage of another vehicle through the intersection with priority and stopping, to the vehicle 130 in response to receiving the passage impossible notification.

In step S905, the fee processing unit 316 receives the information of the finalized fees from the information processing apparatus 110, carries out the transaction of the fees based on the information of the finalized fees, and records the transaction in the distributed ledger. Thereafter, the control unit 302 ends the series of operations of the vehicle control process.

As described above, in the present embodiment, the information processing apparatus 110 acquires information on the transaction condition from the communication apparatuses 140 of the vehicles 130 within a predetermined distance from the traffic light, and controls lighting of the traffic light in response to the transaction conditions being satisfied. At this time, when the lighting of the traffic light is controlled, the payment of the fees is processed so as to collect a fee for priority passage from a party on behalf of vehicle which is caused to perform priority passage. In this manner, when a vehicle passes along a predetermined road, it can pay fees to acquire priority passage. In other words, it becomes possible to pay fees to shorten travel time, and to buy and sell the value of travel time in accordance with the convenience of the user.

In addition, in the present embodiment, when a route for travel is set, by setting a transaction condition in advance and setting a destination, route options that include the fee for priority passage and times required for reaching the destination are displayed. By such a configuration, the user is enabled to easily select a suitable route according to his or her needs so as to pay fees when the travel time is desired to be shortened or receive fees when there is surplus time.

In the embodiment described above, the information processing apparatus 110 acquires information on the transaction condition from the communication apparatus 140 and controls lighting of the traffic light according to the transaction condition, but this processing may be executed by the communication apparatus 140. That is, a predetermined communication apparatus 140 may acquire information on the transaction condition from the surrounding communication apparatuses, determine the transaction condition, and control lighting of a traffic light in the vicinity according to the determination result.

### Second Embodiment

Hereinafter, a second embodiment according to the present invention will be described. In the first embodiment, an example was described in which the information processing apparatus 110 controls a traffic light based on information on a transaction condition, thereby enabling priority passage. In the second embodiment, an example will be described in which priority passage is performed on a road on which overtaking is possible such as an expressway, and further, communication is performed between vehicles, so that one vehicle can causes another vehicle to travel in front of it in order to reduce traveling air resistance. In the following description, the same reference numerals are assigned to the same or substantially the same components as those of the first embodiment, and description thereof is omitted.

<Configuration of Traffic System>

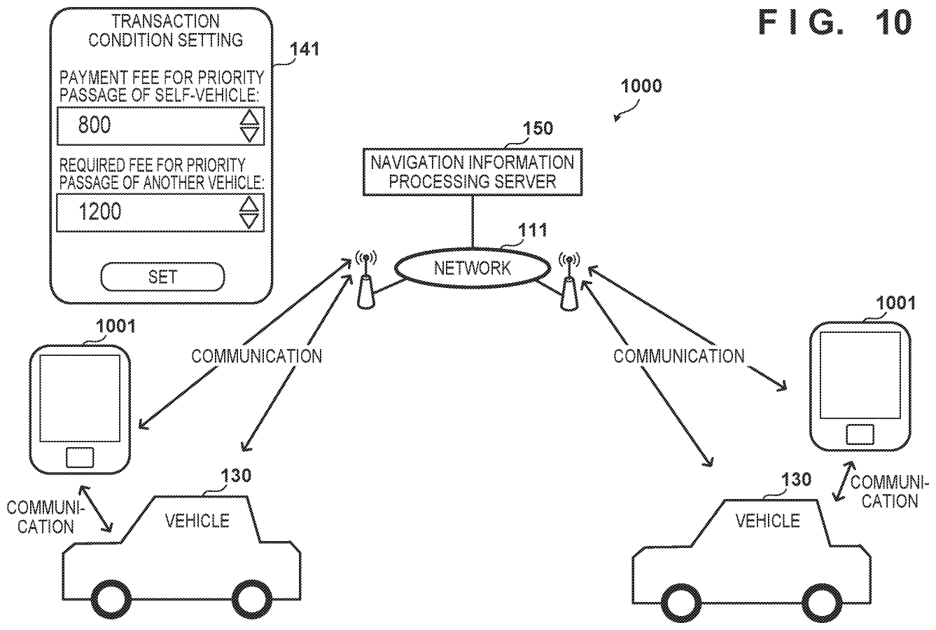

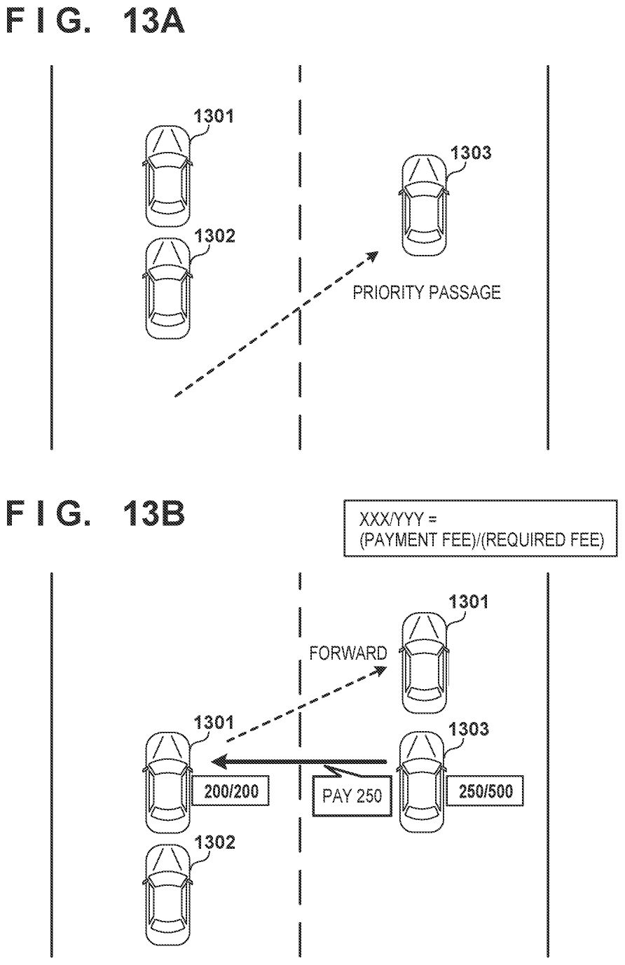

Referring to FIG. 10, the configuration of the traffic system 1000 according to a second embodiment will be described. In the traffic system 1000, a case where the vehicle 130 travels on an expressway as an example of a road on which overtaking is possible will be described as an example. In a normal lane of the expressway, a plurality of vehicles are traveling in a coordinated manner at a speed (for example, 80 km/h) with high fuel consumption efficiency by automated driving (for example, FIG. 13A). On the other hand, in order for the user to pass in an overtaking lane at a higher speed (faster than 80 km/h and within the speed limit), a fee for enabling priority passage is paid. In addition, it is also possible to reduce air resistance at the time of travel by causing one of the other vehicles to travel in front of the self-vehicle (for example, FIG. 13B). In this case, since the self-vehicle can improve power efficiency or fuel efficiency at the time of travel, the self-vehicle can travel over a longer distance without having to replenish electric power or the like (i.e., travel time is shortened as a result, and it amounts to priority passage). In this manner, when a vehicle is caused to travel in front according to the transaction, a fee for enabling the priority passage is paid thereto.

A communication apparatus 1001 is associated with the vehicle 130, for example, by being paired with the vehicle 130 in advance. The communication apparatus 1001 can communicate with the is associated vehicle 130 via wireless communication such as Bluetooth (registered trademark) or the like, and can communicate with other vehicles 130 and the navigation information processing server 150 via the network 111 which may be a mobile communication network.

In order for a user of the vehicle 130 to arrive at a destination utilizing the traffic system 1000, a communication apparatus 1001 associated with the vehicle 130, for example, is used to determine a route to the destination. The communication apparatus 1001 determines a route to a destination in the same manner as in the first embodiment. The fee set in the transaction condition setting screen 162 of FIG. 1B can be used for both the priority passage when passing along a road on which overtaking is possible and the priority passage when other vehicles are caused to travel ahead to reduce the traveling air resistance. At this time, the “a fee to be paid when the self-vehicle is caused to perform priority passage” represents a fee that may be paid for the purpose of shortening the travel time to arrive at the destination early or the like, and is a fee that is paid when overtaking another vehicle on a road on which overtaking is possible. In addition, it represents a payment fee when another vehicle is caused to travel in front of self-vehicle to reduce the air resistance and making travel more efficient. Conversely, the “a fee required for priority passage of another vehicle” is a required fee to be received in exchange for the extension of the travel time, and represents a received fee when self-vehicle travels in front of another vehicle and is subjected to the air resistance. The communication apparatus 1001 of the present embodiment executes the transaction condition determination processing by itself to determine whether or not the transaction condition is satisfied, and, according to the determination result, can control the vehicle 130 to pass along a road on which overtaking is possible, or to travel behind another vehicle while traveling on a road on which overtaking is possible.

<Configuration of the Communication Apparatus 1001>

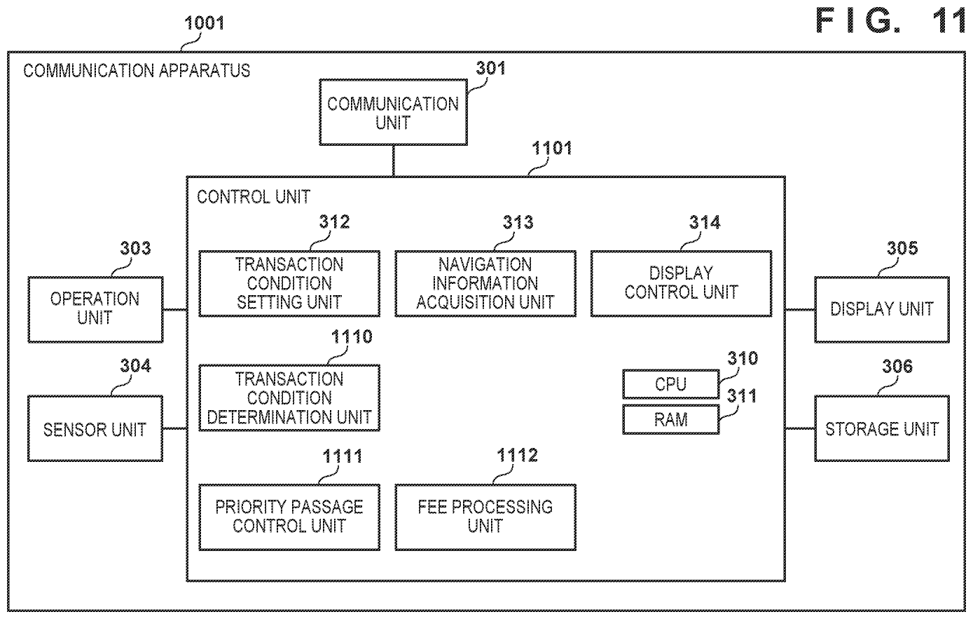

Next, a configuration example of the communication apparatus 1001 will be described with reference to FIG. 11. The configuration illustrated in FIG. 11 illustrates functional blocks configuring a smartphone as an example of the communication apparatus 1001 of the present embodiment. It should be noted that each of the functional blocks described may be integrated or separated, and the functions described may be implemented in separate blocks. Also, what is described as hardware may be implemented in software, or vice versa.

Of the configuration of the communication apparatus 1001, the functional blocks 301 to 306 are the same as those in the first embodiment. The control unit 1101 includes a CPU 310 and a RAM 311, and for example, the CPU 310 executes programs stored in the storage unit 306 to control the respective functional blocks in the control unit 1101 and the operations of the respective units in the communication apparatus 1001. In the configuration of the control unit 1101, the configuration of the transaction condition setting unit 312, the navigation information acquisition unit 313, and the display control unit 314 is the same as that of the first embodiment.

The transaction condition determination unit 1110 compares information of a transaction condition set in its own communication apparatus 1001 with a predetermined fee for passing through an overtaking lane to determine whether the transaction condition is satisfied in order to determine the transaction condition for priority passage on a road on which overtaking is possible. In addition, in the case where another vehicle is caused to travel in front of self-vehicle to reduce the air resistance, it is determined whether or not a transaction condition relating to priority passage is satisfied based on the information of the transaction conditions acquired from the communication apparatuses 1001 associated with other vehicles and the information of the transaction condition set in the self communication apparatus 1001.

In response to the transaction condition determination unit 1110 determining that a transaction condition is satisfied, the priority passage control unit 1111 transmits, to the vehicle 130, a control signal for causing passage through the overtaking lane or causing passage behind another vehicle. The fee processing unit 1112 performs a fee transaction, and records the transaction in the distributed ledger.

<Series of Operations in Vehicle Control Process in Communication Apparatus 1001>

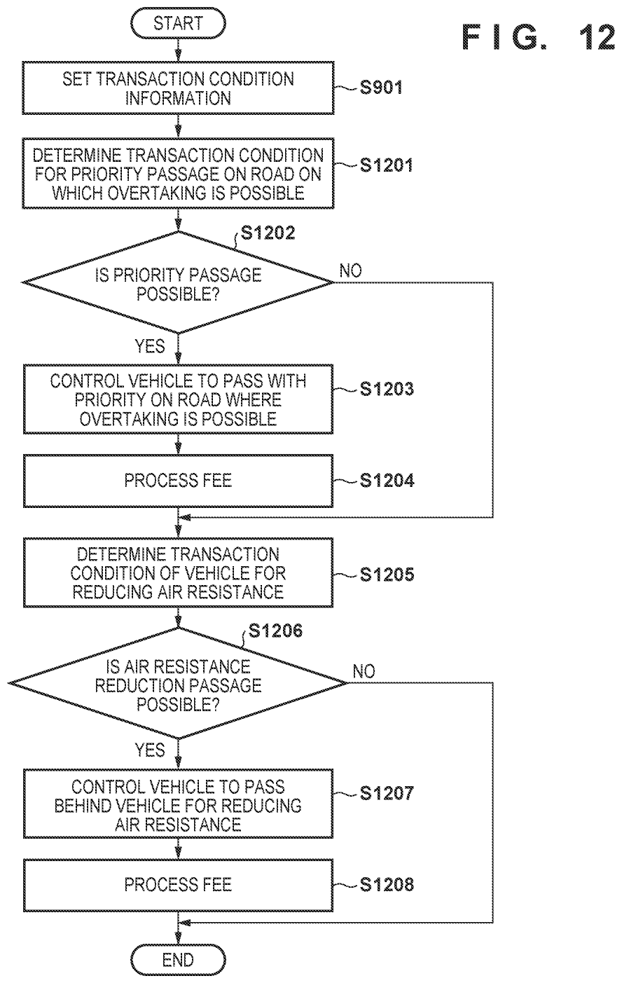

Next, a series of operations of a vehicle control process in the communication apparatus 1001 will be described with reference to FIG. 12. This process is realized by the CPU 310 of the control unit 1101 executing a program stored in the storage unit 306. This processing is started, for example, when vehicles 1301 to 1303 are traveling at a constant speed on the left lane of a road on which overtaking is possible, as illustrated in FIG. 13A. It is also assumed that the communication apparatus 1001 according to the present processing is associated with the vehicle 1303.

In step S901, the transaction condition setting unit 312 of the control unit 1101 sets the information of a transaction condition based on user operation in relation to the above-described transaction condition setting screen 162. The transaction condition setting unit 312 records information of the set transaction condition in the storage unit 306.

In step S1201, the transaction condition determination unit 1110 determines a transaction condition for priority passage on a road on which overtaking is possible. More specifically, a transaction condition is determined to be satisfied when the fee to be paid in a case where priority passage is caused, which is set in step S901, is greater than or equal to a predetermined fee for passing through an overtaking lane. Note that the predetermined fee for passing through the overtaking lane is predetermined for each road by, for example, a management entity that manages roads on which overtaking is possible, and the payment fee is paid to such entities. The fee may be changed in accordance with the time zone, the timing, and congestion conditions.

In step S1202, the control unit 202 proceeds to step S1203 when it is determined that the transaction condition is satisfied, and otherwise proceeds to step S1205. In step S1203, in response to the transaction condition being satisfied, the priority passage control unit 1111 transmits a control signal to the vehicle 1303 for passage with priority (for example, moving to the right lane, increasing the vehicle speed, and overtaking the vehicle).

In step S1204, the fee processing unit 1112 performs a fee transaction based on the fee set in step S901, and records the transaction in the distributed ledger.

Next, a description will be given of an example in which a process of passing with priority which causes another vehicle to travel in front of self-vehicle to reduce the travel air resistance is further executed. Processing of step S1205 may be performed at any time in response to an instruction from the user or automatically. First, in step S1205, in order to perform priority passage to reduce the air resistance, for example, the transaction condition determination unit 1110 acquires information on the transaction condition of the vehicle 1301 traveling in the left lane and compares the information with the fee set in step S901. For example, if the fee to be paid in a case where priority passage is caused, which is set in step S901, is greater than or equal to the fee that the vehicle 1301 can accept, the transaction condition is determined to be satisfied.

In step S1206, the control unit 202 proceeds to step S1207 when it is determined that the transaction condition is satisfied, and otherwise ends the series of operations. In step S1207, in response to the transaction condition being satisfied, the priority passage control unit 1111 transmits a control signal to the vehicle 1303 for passage with priority (for example, travelling close behind the vehicle 1301 after it has moved to the right lane). At this time, the priority passage control unit 1111 can instruct the communication apparatus associated with the vehicle 1301 to cause the vehicle 1301 to move to the right lane in advance.

In step S1208, the fee processing unit 1112 performs a fee transaction (e.g., pays 250 in the example of FIG. 13B) based on the fee set in step S901, and records the transaction in the distributed ledger.

In the present embodiment, description was given of an example of providing information of one transaction condition set in step S901 for various kinds of priority passage, but the fee for each kind of priority travel (e.g., priority travel on a road on which overtaking is possible and priority travel in which another vehicle is caused to travel ahead of self) may be set separately.

As described above, in the present embodiment, information of a transaction condition relating to priority passage on a road on which overtaking is possible is set, and in response to the determination that priority passage on a road on which overtaking is possible is possible based on the information of the set transaction condition, the vehicle is caused to perform priority passage on the road on which overtaking is possible. Also, in the case where the vehicle has been caused to perform priority passage on a road on which overtaking is possible, a fee for the priority passage is paid. By doing so, when travelling on a road on which overtaking is possible, it becomes possible to pay fees to shorten travel time, and to buy and sell the value of travel time in accordance with the convenience of the user.

In addition, in the present embodiment, information of a transaction condition relating to priority passage in which another vehicle is caused to travel ahead to reduce traveling air resistance is set, and in response to the determination that the priority passage in which travelling air resistance is reduced is possible based on the information of the set transaction condition, the vehicle is caused to perform priority passage so that the air resistance at the time of travel is reduced by the other vehicle. Then, in the case where the vehicle is caused to perform priority passage so that travelling air resistance is reduced by the other vehicle, a fee for the priority passage is paid. In this way, the air resistance can be reduced by the other vehicle, and the vehicle can pass over a longer distance in a shorter travel time. In other words, it becomes possible to pay fees to shorten travel time, and to buy and sell the value of travel time in accordance with the convenience of the user.

### Summary of Embodiments

1. The information processing apparatus of the above-described embodiments (for example, reference numeral 110) is

an information processing apparatus that controls lighting of a traffic light (for example, 120), and comprises:

a communication circuit configured to acquire information of a transaction condition on priority passage from a communication apparatus associated with a vehicle within a predetermined distance of the traffic light (for example, 201 and step S502);

one or more processors; and

a memory storing instructions which, when the instructions are executed by the one or more processors, cause the information processing apparatus to function as:

a control unit configured to control lighting of the traffic light according to the transaction condition on priority passage being satisfied, based on the information of the transaction condition (for example, 214, step S506); and

a processing unit configured to process a payment of a fee based on the transaction condition on priority passage (for example, 215),

wherein the processing unit, in a case where lighting of the traffic light has been controlled by the control unit, processes the payment of the fee so as to collect a fee for priority passage from a party on behalf of a vehicle for which priority passage became possible (for example, step S507).

By virtue of this embodiment, when a vehicle passes along a predetermined road, it can pay a fee to acquire priority passage.

2. In the above embodiment,

the processing unit, in a case where lighting of the traffic light has been controlled by the control unit, processes the payment of the fee so as to provide a fee for priority passage to party on behalf of a vehicle that accepted priority passage of another vehicle.

By virtue of this embodiment, it is possible to accept a fee in a case where there is sufficient time and an extension in travel time can be permitted.

3. In the above embodiment,

the control unit, in a case where vehicles within a predetermined distance of the traffic light only pass in one direction, controls lighting of the traffic light treating the transaction condition on priority passage as satisfied (for example, step S503).

By virtue of this embodiment, efficient vehicle movement is enabled by reducing waiting at a signal unnecessarily in a case where vehicles are traveling in only one direction.

4. In the above embodiment,

the processing unit, in a case where lighting of the traffic light has been controlled by the control unit when vehicles within a predetermined distance of the traffic light only pass in one direction, processes payment of the fee so not to collect a fee from the vehicles (for example, step S507).

By virtue of this embodiment, the system will be easy to use since payment of the fee is not required, and early adoption can be expected.

5. In the above embodiment,

information of the transaction condition on priority passage includes an amount to be paid for priority passage and an amount to be required for acceptance of priority passage, which are set for each vehicle (for example, 141),

the processing unit, in a case where there are a plurality of vehicles for which priority passage is possible, processes payment of a fee for priority passage so that the fee is paid on behalf of a vehicle for which a maximum amount to be paid is set in the transaction condition on priority passage (for example, step S507, FIG. 7AA to FIG. 7AB).

By virtue of this embodiment, it is possible to process fees based on a fee of a user who most strongly desires to pass with priority.

6. In the above embodiment,

the processing unit, in a case where there are a plurality of vehicles that accepted the priority passage of another vehicle, processes payment of a fee for the priority passage so that the fee is paid to the vehicle for which a highest amount required for acceptance is set in the transaction condition on priority passage (for example, step S507, FIG. 7BA to FIG. 7BB).

By virtue of this embodiment, it is possible to process a transaction for priority passage based on which user most strongly desires to not sell travel time.

7. In the above embodiment,

the processing unit, in a case where there is a plurality of vehicles that accepted the priority passage of another vehicle, processes payment of a fee for priority passage so that the fee is paid to all vehicles that accepted the priority passage of another vehicle (for example, step S507, FIG. 7BA to FIG. 7BB).

By virtue of this embodiment, it is possible to distribute the fee to all vehicles that accepted the priority passage.

8. In the above embodiment,

in a case where, in information of the transaction condition relating to priority passage, a maximum amount to be paid that is set is greater than or equal to a maximum amount required for acceptance, the transaction condition relating to priority passage is satisfied (for example, step S507, FIG. 7AA to FIG. 7AB).

By virtue of this embodiment, it is possible to determine a transaction considering an intention of a side that most wishes to pass with priority and a side that is least able to permit priority passage.

9. In the above embodiment,

the transaction condition relating to priority passage is determined based on a sum of a set amount to be paid and amount to require for acceptance (for example, FIG. 8A to FIG. 8B).

By virtue of this embodiment, if the sum of the payment fee amount and the required fee amount is used, it is possible to control according to the degree to which the user desires to pass with priority which is represented by each amount.

10. In the above embodiment,

the transaction condition relating to priority passage is determined according to a distance from an intersection to the vehicle in a case where there are same maximum sums of the set amount to be paid and the amount required for acceptance (for example, FIG. 8A to FIG. 8B).

By virtue of this embodiment, when a settlement cannot be made by the transaction condition, it is possible to prioritize a vehicle which is expected to exit the intersection earlier.

11. In the above embodiment,

the control unit, in a case where a vehicle is associated with a communication apparatus that cannot acquire the information of a transaction condition relating to priority passage is included in the vehicles within the predetermined distance of the traffic light, does not control lighting of the traffic light based on the transaction condition.

By virtue of this embodiment, in a case where there is a vehicle that cannot participate in a transaction relating to priority passage, it is possible to treat that vehicle fairly.

12. In the above embodiment,

the fee for priority passage can be exchanged for a currency (for example, step S907 and 163).

By virtue of this embodiment, it is possible to exchange a value corresponding to travel time with a value of a currency.

13. In the above embodiment,

the processing unit processes payment of a fee for the priority passage using a virtual currency (for example, step S907 and 163).

According to this embodiment, a value corresponding to travel time can be bought and sold using a virtual currency.

14. A communication apparatus in the above embodiments (for example, 140)

is a communication apparatus associated with a vehicle (for example, 130) and communicates with an information processing apparatus (for example, 110) that controls lighting of a traffic light, and comprises:

a communication circuit that, for passage controlled by lighting of the traffic light, transmits to the information processing apparatus information of a transaction condition relating to priority passage (for example, 301);

one or more processors; and

a memory storing instructions which, when the instructions are executed by the one or more processors, cause the information processing apparatus to function as:

a control unit configured to cause the vehicle to perform priority passage of a location where passage is controlled by the traffic light in accordance with priority passage becoming possible based on information of the transaction condition by the information processing apparatus (for example, 315);

a processing unit configured to process a payment of a fee based on a transaction condition relating to priority passage (for example, 316),

wherein the processing unit, in a case where the vehicle is caused to perform priority passage of the location where passage is controlled by the traffic light, processes payment of a fee for priority passage so that the fee is paid.

By virtue of this embodiment, when a vehicle passes along a predetermined road, it can pay fees to acquire priority passage.

15. In the above embodiment,

further comprising a setting unit (for example, 312 and 141) configured to set information of a transaction condition relating to priority passage,

wherein the setting unit can set a value of a fee to be paid in a case where priority passage is caused as the transaction condition relating to priority passage (for example, 141).

By virtue of this embodiment, it is possible to set a fee that one does not mind paying for shortening travel time to a desired value considering personal time sufficiency.

16. In the above embodiment,

further comprising a setting unit (for example, 312 and 141) configured to set information of a transaction condition relating to priority passage,

wherein the setting unit can set a value of a fee at which priority passage of another vehicle can be accepted as the transaction condition relating to priority passage.

By virtue of this embodiment, it is possible to set a fee that is required for acceptance in exchange for extending travel time to a desired value considering personal time sufficiency.

17. A method for controlling the information processing apparatus of the above-described embodiments

is a method for controlling an information processing apparatus for controlling lighting of a traffic light, and comprises:

a communication step of acquiring information of a transaction condition relating to priority passage from a communication apparatus associated with a vehicle within a predetermined distance of the traffic light (for example, step S502);

a control step configured to control lighting of the traffic light according to a transaction condition related to priority passage being satisfied based on the information of the transaction condition (for example, step S506); and

a processing step of processing a payment of a fee based on a transaction condition relating to priority passage (for example, step S507),

wherein in the processing step, in a case where lighting of the traffic light has been controlled in the control step, processes the payment of the fee so as to collect a fee for priority passage from a party on behalf of a vehicle for which priority passage became possible.

By virtue of this embodiment, when a vehicle passes along a predetermined road, it can pay fees to acquire priority passage.

18. A method for controlling the communication apparatus of the above-described embodiments

is a method for controlling a communication apparatus that is associated with a vehicle and communicates with an information processing apparatus for controlling lighting of a traffic light, and comprises:

a communication step of, for passage controlled by lighting of the traffic light, transmitting, to the information processing apparatus, information of a transaction condition relating to priority passage (for example, step S902);

a control step of causing the vehicle to perform priority passage of a location where passage is controlled by the traffic light in accordance with priority passage becoming possible based on information of the transaction condition by the information processing apparatus (for example, step S905); and

a processing step of processing a payment of a fee based on a transaction condition relating to priority passage (for example, step S907),

wherein in the processing step, payment of a fee for priority passage is processed so as to pay the fee in a case where the vehicle is caused to perform priority passage of the location where passage is controlled by the traffic light.

By virtue of this embodiment, when a vehicle passes along a predetermined road, it can pay fees to acquire priority passage.

The invention is not limited to the foregoing embodiments, and various variations/changes are possible within the spirit of the invention.

What is claimed is:

1. An information processing apparatus that is for controlling lighting of a traffic light, the apparatus comprising:
a communication circuit configured to acquire information of a transaction condition relating to priority passage from a communication apparatus associated with a vehicle within a predetermined distance of the traffic light;
one or more processors; and
a memory storing instructions which, when the instructions are executed by the one or more processors, cause the information processing apparatus to function as:
a control unit configured to control lighting of the traffic light according to the transaction condition on priority passage being satisfied, based on the information of the transaction condition; and
a processing unit configured to process a payment of a fee based on the transaction condition on priority passage,
wherein the processing unit, in a case where lighting of the traffic light has been controlled by the control unit, processes the payment of the fee so as to collect a fee for priority passage from a party on behalf of a vehicle for which priority passage became possible.

2. The information processing apparatus according to claim 1, wherein the processing unit, in a case where lighting of the traffic light has been controlled by the control unit, processes the payment of the fee so as to provide a fee for priority passage to a party on behalf of a vehicle that accepted priority passage of another vehicle.

3. The information processing apparatus according to claim 1, wherein the control unit, in a case where vehicles within a predetermined distance of the traffic light only pass in one direction, controls lighting of the traffic light treating the transaction condition on priority passage as satisfied.

4. The information processing apparatus according to claim 3, wherein the processing unit, in a case where lighting of the traffic light has been controlled by the control unit when vehicles within a predetermined distance of the traffic light only pass in one direction, processes payment of the fee so not to collect a fee from the vehicles.

5. The information processing apparatus according to claim 2, wherein information of the transaction condition on priority passage includes an amount to be paid for priority passage and an amount to be required for acceptance of priority passage, which are set for each vehicle,
the processing unit, in a case where there are a plurality of vehicles for which priority passage is possible, processes payment of a fee for priority passage so that the fee is paid from a vehicle for which a maximum amount to be paid is set in the transaction condition on priority passage.

6. The information processing apparatus according to claim 2, wherein the processing unit, in a case where there are a plurality of vehicles that accepted the priority passage of another vehicle, processes payment of a fee for the priority passage so that the fee is paid to the vehicle for which a highest amount required for acceptance is set in the transaction condition on priority passage.

7. The information processing apparatus according to claim 2, wherein the processing unit, in a case where there is a plurality of vehicles that accepted the priority passage of another vehicle, processes payment of a fee for priority passage so that the fee is paid to all vehicles that accepted the priority passage of another vehicle.

8. The information processing apparatus according to claim 6, wherein in a case where, in information of the transaction condition relating to priority passage, a maximum amount to be paid that is set is greater than or equal to a maximum amount required for acceptance, the transaction condition relating to priority passage is satisfied.

9. The information processing apparatus according to claim 5, wherein the transaction condition relating to priority passage is determined based on a sum of a set amount to be paid and amount to require for acceptance.

10. The information processing apparatus according to claim 9, wherein the transaction condition relating to priority passage is determined according to a distance from an intersection to the vehicle in a case where there are same maximum sums of the set amount to be paid and the amount required for acceptance.

11. The information processing apparatus according to claim 1, wherein the control unit, in a case where a vehicle is associated with a communication apparatus that cannot acquire the information of a transaction condition relating to priority passage is included in the vehicles within the predetermined distance of the traffic light, does not control lighting of the traffic light based on the transaction condition.

12. The information processing apparatus according to claim 1, wherein the fee for priority passage can be exchanged for a currency.

13. The information processing apparatus according to claim 12, wherein the processing unit processes payment of a fee for the priority passage using a virtual currency.

14. A communication apparatus that is for communicating with an information processing apparatus for controlling lighting of a traffic light and that is associated with a vehicle, the communication apparatus comprising:
a communication circuit that, for passage controlled by lighting of the traffic light, transmits to the information processing apparatus information of a transaction condition relating to priority passage;
one or more processors; and
a memory storing instructions which, when the instructions are executed by the one or more processors, cause the communication apparatus to function as:
a control unit configured to cause the vehicle to perform priority passage of a location where passage is controlled by the traffic light in accordance with priority passage becoming possible based on information of the transaction condition by the information processing apparatus; and
a processing unit configured to process a payment of a fee based on the transaction condition on priority passage,
wherein the processing unit, in a case where the vehicle is caused to perform priority passage of the location where passage is controlled by the traffic light, processes payment of a fee for priority passage so that the fee is paid.

15. The communication apparatus according to claim 14, the instructions cause the communication apparatus further functions as a setting unit configured to set information on a transaction condition relating to priority passage,
wherein the setting unit can set a value of a fee to be paid in a case where priority passage is caused as the transaction condition relating to priority passage.

16. The communication apparatus according to claim 14, further comprising a setting unit configured to set information on a transaction condition relating to priority passage,
wherein the setting unit can set a value of a fee at which priority passage of another vehicle can be accepted as the transaction condition relating to priority passage.

17. A method for controlling an information processing apparatus that is for controlling lighting of a traffic light, the method comprising:
acquiring information of a transaction condition relating to priority passage from a communication apparatus associated with a vehicle within a predetermined distance of the traffic light;
controlling lighting of the traffic light according to the transaction condition on priority passage being satisfied, based on the information of the transaction condition; and
processing a payment of a fee based on the transaction condition on priority passage,
wherein in the processing step, in a case where lighting of the traffic light has been controlled in the control step, processes the payment of the fee so as to collect a fee for priority passage from a party on behalf of a vehicle for which priority passage became possible.

18. A method for controlling a communication apparatus that is for communicating with an information processing apparatus for controlling lighting of a traffic light and that is associated with a vehicle, the communication apparatus comprising:
for passage controlled by lighting of the traffic light, transmitting, to the information processing apparatus, information of a transaction condition relating to priority passage;
causing the vehicle to perform priority passage of a location where passage is controlled by the traffic light in accordance with priority passage becoming possible based on information of the transaction condition by the information processing apparatus; and
processing a payment of a fee based on a transaction condition relating to priority passage,
wherein in the processing step, payment of a fee for priority passage is processed so as to pay the fee in a case where the vehicle is caused to perform priority passage of the location where passage is controlled by the traffic light.

19. A non-transitory computer-readable storage medium storing a program that is for causing a computer to function as each unit of a communication apparatus, wherein
the communication apparatus is associated with a vehicle and communicates with an information processing apparatus for controlling lighting of a traffic light, and comprises:
a communication unit configured to, for passage controlled by lighting of the traffic light, transmit to the information processing apparatus information of a transaction condition relating to priority passage;
a control unit configured to cause the vehicle to perform priority passage of a location where passage is controlled by the traffic light in accordance with priority passage becoming possible based on information of the transaction condition by the information processing apparatus; and
a processing unit configured to process a payment of a fee based on the transaction condition on priority passage,
wherein the processing unit, in a case where the vehicle is caused to perform priority passage of the location where passage is controlled by the traffic light, processes payment of a fee for priority passage so that the fee is paid.
